(19) United States
(12) Patent Application Publication
(10) Pub. No.: US 2025/0280304 A1
(43) Pub. Date: Sep. 4, 2025

(54) Machine Learning for Radio Access Network Optimization

(71) Applicant: Telefonaktiebolaget LM Ericsson (publ), Stockholm (SE)

(72) Inventors: Maxime Bouton, Stockholm (SE); Viktor Eriksson Möllerstedt, Stockholm (SE); Andreas Johnsson, Uppsala (SE)

(21) Appl. No.: 18/858,579

(22) PCT Filed: Jun. 6, 2023
(86) PCT No.: PCT/SE2023/050566

§ 371 Date: Oct. 21, 2024

Related U.S. Application Data
(60) Provisional application No. 63/349,634, filed on Jun. 7, 2022.

(51) Int. Cl. H04W 24/02; H04L 41/16; H04W 24/06

(52) U.S. Cl. CPC H04W 24/02; H04L 41/16; H04W 24/06

(57) ABSTRACT

A computer-implemented method is provided performed by a network node (600, 1200) including a first machine learning, ML, model (105) representing an enhanced policy to optimize a radio access network, RAN. The method includes receiving (901) an initial policy. The method further includes training (903) a second ML model based on a plurality of interactions with an environment including a portion of the RAN. The method further includes training (909) the first ML learning model to learn the enhanced policy with data from the trained second ML model and the environment; and deploying (911) the trained first ML model including the enhanced policy to optimize the RAN.

### TECHNICAL FIELD

The present disclosure relates generally to methods performed by a network node including a first machine learning (ML) model representing an enhanced policy to optimize a radio access network (RAN), and related methods and apparatuses.

### BACKGROUND

Automatically configuring base station parameters has been considered in some rule-based policies and reinforcement learning approaches. For example, for the control of Remote Electrical Tilt (RET) in order to try to optimize coverage, quality and capacity. A self-organizing network (SON) algorithm is a rule-based method that may be capable of tuning a RET algorithm. In some approaches, deep Q-learning algorithms may have been shown to outperform such a rule-based method and may optimize mobile networks by incrementing or decrementing a tilt angle to maximize a reward function. One challenge with this approach includes that it may require thousands of interactions with a simulated environment to learn good strategies. Moreover, once deployed, a deep Q-learning algorithm may be expected to continue training in the real network. In case of environmental changes, however, the policy may require many interactions to adapt properly.

Presently, reinforcement learning models for continuous control tasks may require a large number of interactions with the environment i.e., the ML model requires to be trained on a lot of data samples before reaching a good performance, in such a scenario it is said to have poor sample efficiency. For real-world applications, these interactions can be very expensive (e.g., computation cost, cost of operation, etc.) and risky. As used herein, the phrase “machine learning” or “ML” includes, without limitation, reinforcement learning (RL). Thus, it may be important to design ML models that can learn efficient policies in as few interactions as possible.

### SUMMARY

There currently exist certain challenges. A ML model to optimize a RAN that may be sample efficient or improve sample efficiency may be lacking.

Certain aspects of the disclosure and their embodiments may provide solutions to these or other challenges.

In various embodiments of the present disclosure, a computer-implemented method is provided performed by a network node including a first ML model representing an enhanced policy to optimize a radio access network, RAN. The method includes receiving an initial policy. The method further includes training a second ML model based on a plurality of interactions with an environment comprising a portion of the RAN. The method further includes training the first ML learning model to learn the enhanced policy with data from the trained second ML model and the environment; and deploying the trained first ML model comprising the enhanced policy to optimize the RAN.

In other embodiments, a network node is provided including a first ML mode representing an enhanced policy to optimize a RAN. The network node includes at least one processing circuitry; and at least one memory coupled with the processing circuitry, wherein the memory includes instructions that when executed by the processing circuitry causes the network node to perform operations. The operations include to receive an initial policy. The operations further include to train a second ML model based on a plurality of interactions with an environment comprising a portion of the RAN. The operations further include to train the first ML learning model to learn the enhanced policy with data from the trained second ML model and the environment; and to deploy the trained first ML model comprising the enhanced policy to optimize the RAN.

In other embodiments, a network node is provided including a first ML mode representing an enhanced policy to optimize a RAN; and the network node is adapted to perform operations. The operations include to receive an initial policy. The operations further include to train a second ML model based on a plurality of interactions with an environment comprising a portion of the RAN. The operations further include to train the first ML learning model to learn the enhanced policy with data from the trained second ML model and the environment; and to deploy the trained first ML model comprising the enhanced policy to optimize the RAN.

In other embodiments, a computer program comprising program code is provided to be executed by processing circuitry of a network node comprising a first ML model representing an enhanced policy to optimize a RAN, whereby execution of the program code causes the network node to perform operations. The operations include to receive an initial policy. The operations further include to train a second ML model based on a plurality of interactions with an environment comprising a portion of the RAN. The operations further include to train the first ML learning model to learn the enhanced policy with data from the trained second ML model and the environment; and to deploy the trained first ML model comprising the enhanced policy to optimize the RAN.

In other embodiments, a computer program product is provided comprising a non-transitory storage medium including program code to be executed by processing circuitry of a network node comprising a first ML model representing an enhanced policy to optimize a RAN, whereby execution of the program code causes the network node to perform operations. The operations include to receive an initial policy. The operations further include to train a second ML model based on a plurality of interactions with an environment comprising a portion of the RAN. The operations further include to train the first ML learning model to learn the enhanced policy with data from the trained second ML model and the environment; and to deploy the trained first ML model comprising the enhanced policy to optimize the RAN.

Certain embodiments may provide one or more of the following technical advantages. The method may improve sample efficiency based on learning the enhanced policy in less interactions with the environment.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a schematic diagram illustrating an overview of operations of a method in accordance with some embodiments of the present disclosure;

FIG. 2 is a flow chart of operations of a method in accordance with some embodiments of the present disclosure;

FIG. 3 is a signalling diagram illustrating a method in accordance with some embodiments of the present disclosure;

FIG. 4 is a schematic diagram illustrating an overview of operations of a method in accordance with some embodiments of the present disclosure;

FIGS. 5A-5D are plots comparing an example embodiment of the present disclosure to other approaches;

FIG. 6 is a block diagram of a network node in accordance with some embodiments of the present disclosure;

FIG. 7 is a schematic diagram of an open-RAN (O-RAN) environment in which a network can be deployed in accordance with some embodiments of the present disclosure;

FIG. 8 is a schematic diagram of block diagram of third generation partnership project (3GPP) network in which a network node of the present disclosure can be deployed in accordance with some embodiments of the present disclosure;

FIG. 9 is a flowchart illustrating operations of a network node in accordance with some embodiments of the present disclosure;

FIG. 10 is a block diagram of a communication system in accordance with some embodiments;

FIG. 11 is a block diagram of a user equipment in accordance with some embodiments

FIG. 12 is a block diagram of a network node in accordance with some embodiments;

FIG. 13 is a block diagram of a host computer communicating with a user equipment in accordance with some embodiments;

FIG. 14 is a block diagram of a virtualization environment in accordance with some embodiments; and

FIG. 15 is a block diagram of a host computer communicating via a base station with a user equipment over a partially wireless connection in accordance with some embodiments in accordance with some embodiments.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

As used herein, the term “network node” refers to equipment capable, configured, arranged, and/or operable to include a first ML model representing an enhanced policy to optimize a RAN. As discussed further herein, examples of network nodes include, but are not limited to, centralized or distributed base stations in the RAN (e.g., g Node Bs (gNBs), evolved Node Bs (eNBs), core network nodes, access points (APs) (e.g., radio access points) etc.); a centralized or distributed network data analytics function (NWDAF) in a 3GPP network; an r-app in non-real time RAN intelligent controller (RIC) in an O-RAN, etc.

While embodiments herein are explained in the non-limiting context of a model-based residual learning policy for antenna tuning, the invention is not so limited. Instead, the method of the present disclosure may be used for optimization of any RAN parameter including, without limitation, tuning an antenna tilt, setting an azimuth angle of an antenna, setting a downlink transmission power of an antenna, setting an individual offset of a cell, setting an uplink power, setting a downlink power, and setting a quality of service, QoS, class in a cell, etc.

Some approaches to try to improve the sample efficiency (that is. the number of interactions to reach a good performance/convergence) of a ML model include:
Residual Policy Learning (RPL) as explained in T. Silver, K. Allen, J. Tenenbaum, L. Kaelbling, “Residual Policy Learning”, arxiv.org/pdf/1812.06298.pdf (3 Jan. 2019), discusses learning a correction term to an existing expert policy. By using the expert policy, the approach may allow the agent to start with a better performance than without the expert policy.
Model-based Reinforcement Learning as explained in M. Janner, J. Fu, M. Zhang, S. Levine, “When to Trust Your Model: Model-Based Policy Optimization”, arxiv.org/pdf/1906.08253.pdf (29 Nov. 2021), discusses learning a ML model of the environment and then using the ML model to generate more data. Such an approach may help the ML model converge to a good policy faster by efficiently reusing the data collected in the environment.

There currently exist certain challenges. Existing ML models, such as RPL, may be extensions to deep deterministic policy gradient algorithms. They may allow reuse of existing knowledge from an expert policy but the ML models they are based on may not be sample efficient.

Additionally, while model-based RL algorithms may be more sample efficient, they do not leverage existing knowledge in the form of an expert policy. Moreover, model-based RL algorithms may not have been applied to antenna tuning use cases, or other optimizations of a RAN parameter.

Existing approaches applied to antenna tuning or other RAN parameter optimization may not reuse knowledge from already available policies to improve their sample efficiencies. Instead, such approaches may learn from scratch which may take a long time for the ML model to reach a desired performance. Additionally, such approaches may not perform any type of data augmentation using a learned model.

Thus, there is a need for an ML-based method that improves sample efficiency.

Certain aspects of the disclosure and their embodiments may provide solutions to these or other challenges. In some embodiments, the method includes learning an additive correction term that is combined with an initial policy for e.g., an expert policy. The additive correction term is also referred to herein as a “learned residual policy”. The method further includes a learned ML model of the environment. The residual policy is learned in a model-based fashion using imaginary trajectories sampled from the learned ML model as opposed to, e.g., sampled from the environment in an original RPL model) The method may be applied to improve existing control strategies in antenna tuning use cases or other RAN optimization use cases for e.g., continuous control tasks and other antenna control tasks. The method combines residual policy learning and model-based reinforcement learning for optimizing a RAN for e.g., a RAN parameter(s). In some embodiments, the method enhances an existing antenna tuning policy or other RAN parameter policy using RL for e.g., as opposed to training a new policy from scratch.

Certain embodiments may provide one or more of the following technical advantages. The method may improve sample efficiency based on learning the enhanced policy in fewer interactions with the environment. Additionally, such learning may accelerate the training of an ML agent by using an existing initial policy, and more training data may be generated using a learned ML model.

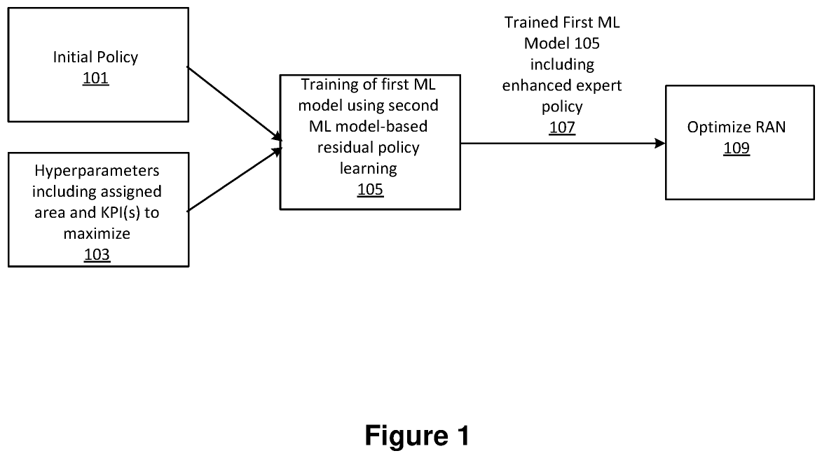

FIG. 1 is a schematic diagram illustrating an overview of operations of a method in accordance with some embodiments of the present disclosure. The operations include training a first ML model 105 to optimize 109 a RAN for e.g., optimize a parameter(s) of the RAN. The first ML model 105 may control one or more base stations and may change a parameter(s) of a base station(s) for e.g., tilt, power, azimuth, frequency, etc. in order to maximize e.g., optimize, a desired network performance indicators or a combination of desired network performance indicators for e.g., key performance indicators (KPIs) such as coverage, capacity, quality, etc.

The method of various embodiments uses knowledge from an initial policy 101, which may accelerate the training; and training of first ML model 105 uses a second ML model-based residual policy learning in a simulation or in a real RAN environment as discussed further herein. The method includes interactions with the environment from inputted hyperparameters 103 including, e.g., an assigned area such as an identified antenna(s) in the RAN and KPI(s) to maximize. The interactions with the environment may include: upon observing a state s, the first ML model 105 takes an action a. The action is executed in the RAN by changing a parameter(s) for e.g., a parameter(s) of the relevant base stations. A new state s′ is observed after the change is executed, and a reward r based on the KPIs to optimize is computed.

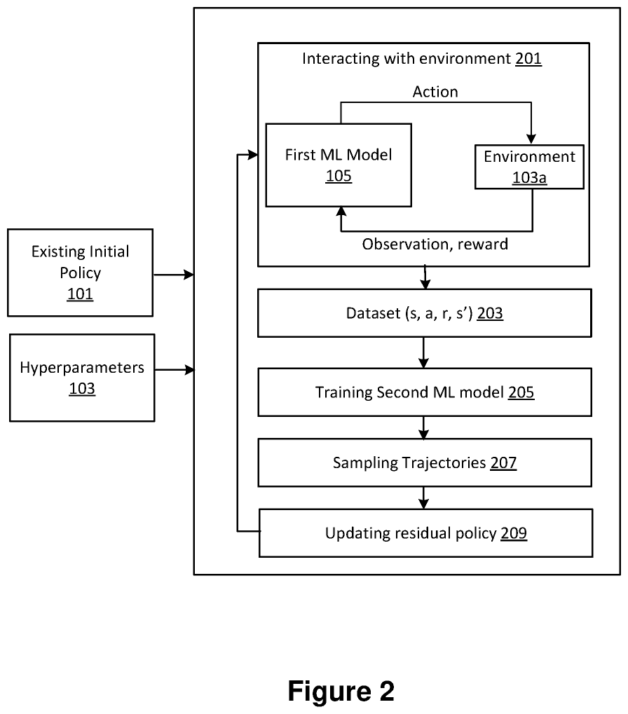

FIG. 2 is a flow chart of operations of a method in accordance with some embodiments of the present disclosure. Inputs to the method include an existing initial policy 101 and hyperparameters 103. The initial policy 101 may include a mapping from observation to action. Initial policy 101 may use a different set of features than the correction term. Initial policy 101 can be obtained by a rule-based policy, or a learned policy. In the case of a learned policy, initial policy 101 may be a policy learned in a slightly different environment, or in simulation for example. For antenna control use cases, deep Q-learning algorithm may be used to obtain such policies, or fuzzy logic based methods. Initial policy 101 also may be stochastic. Initial policy 101 may be defined as πₑ:s→a.

In some embodiments, first ML model 105 includes a combination of initial policy 101 and the learned residual policy. The residual policy may be initialized to 0 at the beginning of the training so that it does not affect the behavior of the initial policy 101 in early stages of training. In some embodiments, a combination is an addition: w(s)=πₑ(s)+δ(s; ϕ), where δ is a learnable function. 8 can be represented by a neural network, or any differentiable parametric representation. As previously discussed, the learnable function is referred to herein as a residual policy.

The residual policy (also referred to herein as a correction term) 8, may be initialized such that its output is 0 at the beginning of the training. As such, first ML model 105 may only be using the initial policy 101 at the beginning.

In some embodiments, the method is an actor-critic method. Thus, an additional function Q(s, a; ψ) may be initialized that is trained to estimate the performance of first ML model 105. This function may be a neural network that is used for training only and not for inference.

Still referring to FIG. 2, in some embodiments, the method includes learning δ in a model-based fashion using the following operations 201-209:

In block 201, the method includes interacting with the environment. This operation includes an RL procedure where first ML model 105 proposes an action and the environment 103a returns a next state and a reward. An action is given by sampling from π(s)=πₑ(s)+δ(s; θ). Exploration strategies and safety mechanism also may be used to select the action from the first ML model 105. Gaussian noise may be added for exploration if the policy is deterministic:

$$a = {π}_{e} ( s ) + δ ( s ) + w$$

Where w˜N(0,σ).

In operation 203, each interaction (s, a, r, s′) is stored in a dataset e.g., in a buffer like a replay buffer. The buffer may have a fixed size. When the buffer is full, old data samples may be discarded to be replaced by the newer data samples.

In operation 205, a second ML model is trained. The second ML model may be a probabilistic transition model P(s′|s, a) of the environment and the learning may use data from the buffer.

The second ML model may be represented by a multivariate Gaussian distribution with a mean and variance parameterized by a neural network:

p(s′|s,a;θ)=N(s′|μ(s,a;θ),Σ(s,a;θ))

Any differentiable parametric distribution representation may be valid.

Given a batch of samples (s, a, r, s′), the second ML model may be trained using gradient descent by maximizing a log-likelihood metric.

Unlike some existing model-based reinforcement learning algorithms, the reward function may be known for e.g., because KPIs to maximize may be given by a network operation center and/or decided from business intents.

In operation 207, sampling of trajectories is performed. After the second ML model is updated, trajectories may be sampled from the second ML model to create a batch of synthetic data. In some embodiments, a multi-update operation is performed, which may further improve sample efficiency:

Algorithm 1: Multi-update actor-critic (AC) learning operation

```
Require: Batch (sₜ, aₜ, rₜ, sₜ₊₁), transition model P_{θ}, initial policy πₑ, policy correction
term δ, reward function r, interval (also referred to as horizon) H, standard deviation
of noise σ
for T = t, T + +, while T ≤ H do
  if T > t then
      a_{T} = πₑ(s_{T}) + δ(s_{T}) + N(0, σ)
    s_{T+1} ~ P_{θ}(s′ | s_{T}, a_{T})
      r_{T} = r(s_{T}, a_{T}, s_{T+1})
end if
  Perform actor-critic update using (s_{T}, a_{T}, r_{T}, s_{T+1})
end for
```

In some embodiments, the interval H, the batch size, and the exploration noise are hyperparameters of the method. Each of the generated trajectories may start from real states that are observed in the environment.

In operation 209, updating of the residual policy is performed. Using the sampled experience (s_{τ}, a_{τ}, r_{τ}, s_{τ+1}) an update mechanism may be used to update the residual policy used by the first ML model 105, as follows.

ϕ is residual parameters of the residual policy. The parameters can be updated using the following soft actor critic approach:

### The Residual Parameter May be Updated by Gradient Descent:

$$ϕ ← ϕ + {w}_{1} {∇}_{ϕ} [ Q ( s , {π}_{e} ( s ) + δ ( s ; ϕ ) ) - α log ( {π}_{e} ( s ) + δ ( s ) ) ]$$

### The Critic May be Updated by Gradient Descent:

$$ψ ← ψ + {w}_{2} {∇}_{ψ} [ ( Q ( s , a ) - r + γ ( Q ( {s}^{′} , {a}^{′} ) - α log π ( s ) ] where {a}^{′} ∼ π ( s )$$

where W₁, W₂ are learning rates, and a is a hyperparameter controlling the importance of the entropy regularization.

The two update equations may be performed multiple times, for each of the batches of states sampled from the trajectories, as described in Algorithm 1.

Once the residual policy is updated, the first ML model 105 may take a new action and the training loop repeats.

The method may include a burn-in mechanism. In an example embodiment, at the beginning of the training, the residual policy is 0 and only the initial policy is acting. Since the critic is not trained, a burn-in period may be included as a hyperparameter of the method. During the burn-in period, only the critic is updated the initial policy is left unchanged. As a consequence, the performance of the initial policy is undisturbed in early training and updating of the residual policy may start when the model and critic are sufficiently trained.

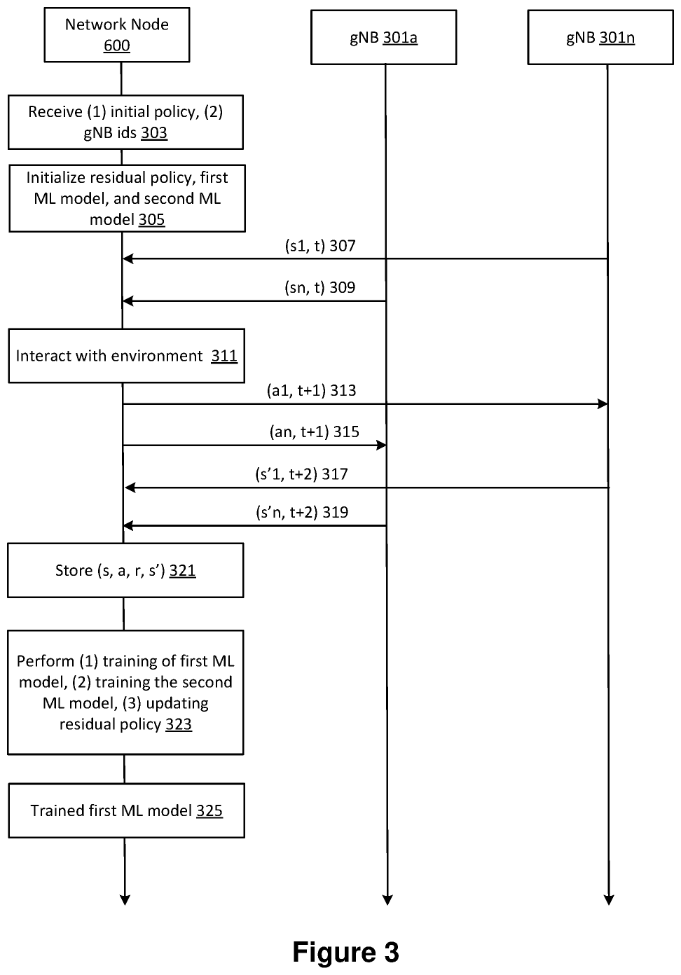

FIG. 3 is a signalling diagram illustrating a method in accordance with some embodiments of the present disclosure. As shown in FIG. 3, network node 600 (discussed further herein) performs the method and includes the first ML model. Network node 600 interacts with gNBs 301a-301n in a RAN. Initially, in operation 303, network node 600 receives an initial policy from a management system as well as the set of gNBs 301a, 301n information such as identifiers (ids) to control. Additionally, the residual policy and the initial policy are initialized.

In operations 305-315, at time t, network node 600 receives a system state s1 and sn from gNB 301a and gNB 301n, respectively (operations 307, 309). In an example embodiment, this corresponds to antenna tilt parameters. The first ML model derives an action based on the received states and calculated reward (operations 311). The action is then communicated to the gNB 301a and gNB 301n at time t+1 (operations 313, 315).

At time t+2, network node 600 receives another set of state updates from the gNB 301a, 301n (operations 317, 319).

In operation 321, a vector (s, a, r, s′) is stored in a buffer e.g., within the first ML model. In operation 323, the network node 600 performs the logical operation corresponding to (1) model learning, (2) training the second ML model, and (3) residual policy updates as discussed herein. Based upon this, the initial policy is updated to generate an enhanced policy. In operation 325, the enhanced policy is ready to be used when new states are received from gNBs 301a, 301n, or if the first ML model decides to take an action based on another criteria.

In some embodiments learning of the residual policy to an initial policy may accelerate training. In some embodiments, this approach is combined with learning a residual policy to the second ML model.

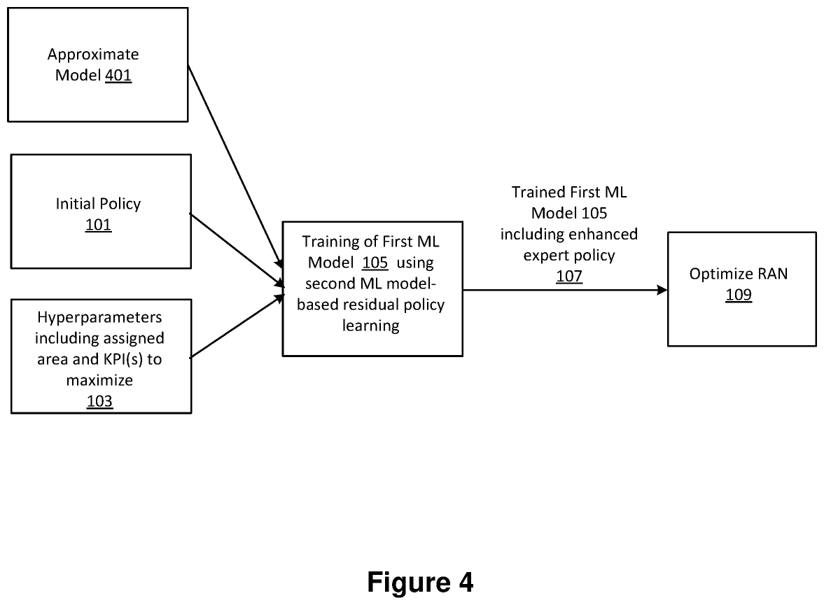

For example, as illustrated in FIG. 4, in the model learning operation, instead of representing the whole model by a neural network, the method can again learn a residual policy:

$$p ( {s}^{′} \vert s , a ; θ ) = N ( {s}^{′} \vert μ ( s , a ; θ ) + {f}_{e} ( {s}^{′} \vert s , a ) , Σ ( s , a ; θ ) )$$

where fₑ is an approximate model 401, and fₑ can be deterministic and given by a simulator or a previously learned model on a slightly different environment.

An example embodiment of the method against other approaches was performed in an experiment on a benchmark environment and an antenna tilt optimization problem. A comparison of the following methods was included in the experiment: (1) a residual policy learning (RPL) based on a method discussed in T. Silver, K. Allen, J. Tenenbaum, L. Kaelbling, “Residual Policy Learning”, arxiv.org/pdf/1812.06298.pdf (3 Jan. 2019); (2) a soft actor critic (SAC) method that did not use a model or an initial policy; (3) a model-based SAC that included model-based updating of a policy from sampled trajectories but without using an initial policy; and (4) an example embodiment of a method in accordance with some embodiments of the present disclosure that used model-based RPL-SAC that combined a model-based approach with an initial policy.

The experiment was applied to an antenna tilt optimization environment. The environment included 21 antennas, and each antenna included an RL agent. To help improve sample efficiency, the data of all the antennas was shared in a common replay buffer and the same model and policy was used for all of the antennas. The experiment included:
Observation: current tilt angle, coverage level in the cell, quality level in the cell, capacity level in the cell.
Action: a change in tilt given by a continuous value between [−1, 1].
Reward: a combination of average signal to interference and noise ratio (SINR), average reference signal received power (RSRP), and average throughput of a cell.

While the experiment included these design choices, the method of the present disclosure is not so limited and all or some of the observation, action, and reward may be different depending on what is being optimized in the RAN.

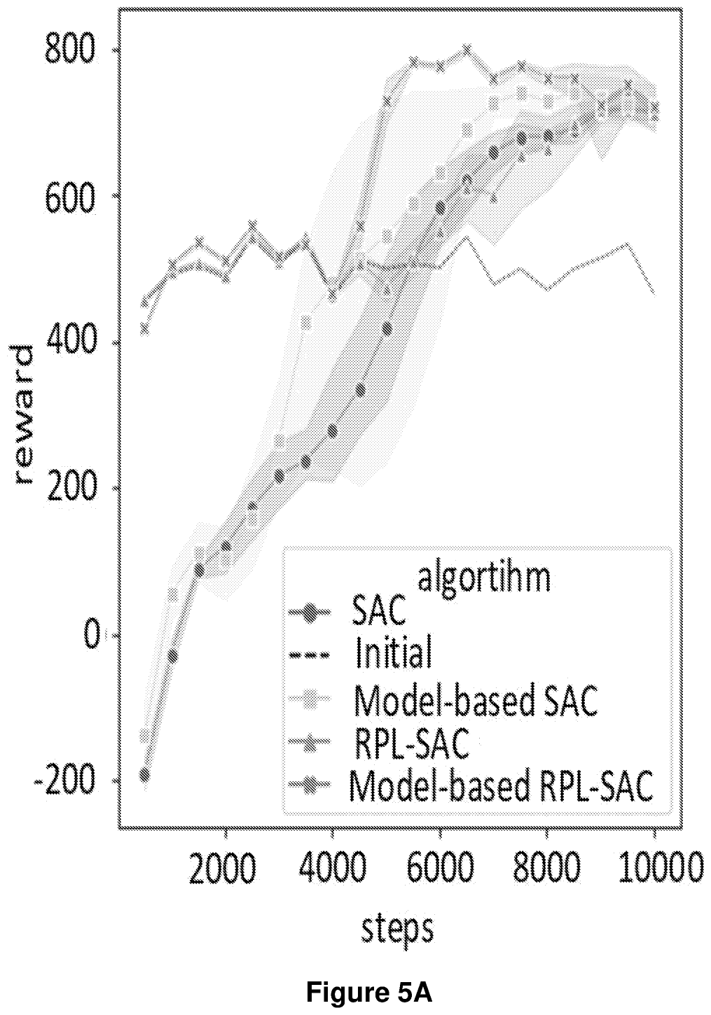

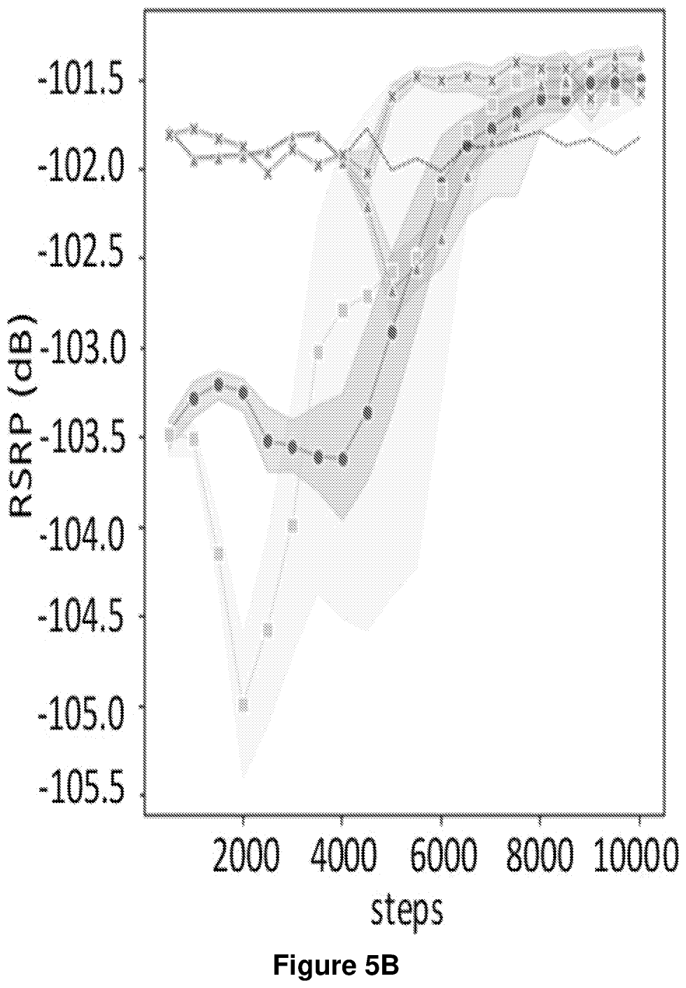

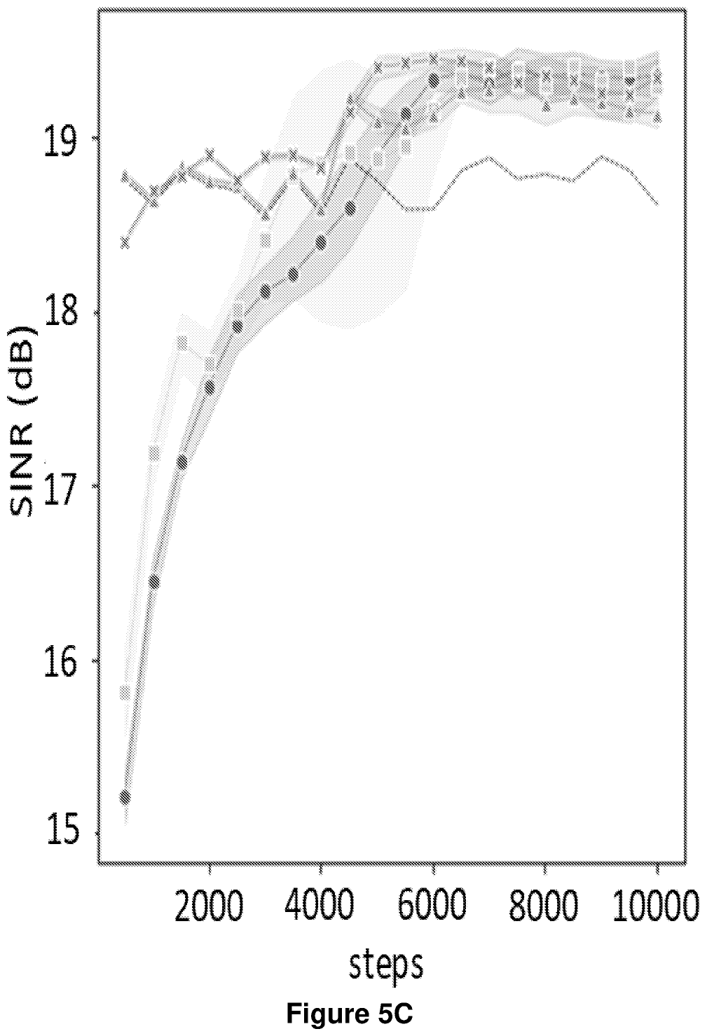

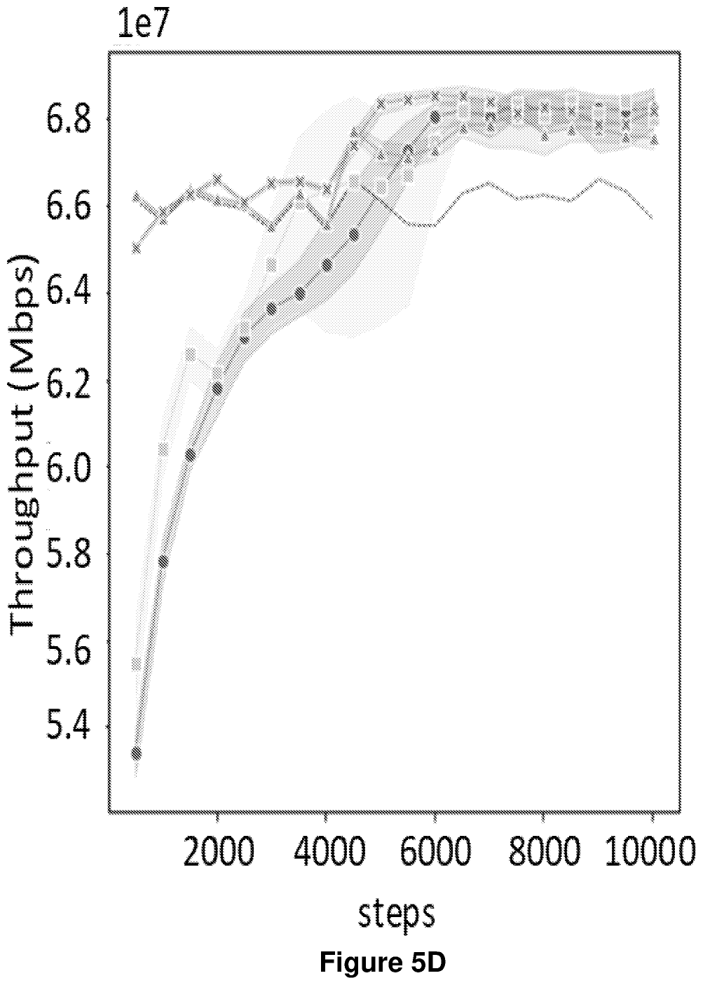

FIGS. 5A-5D are plots from the experiment for the SAC-based methods in the antenna environment and the initial policy trained in an outdoor environment. As shown in FIGS. 5A-5D, the model-based RPL-SAC method of the present disclosure converged significantly faster than all of the other methods. The initial policy included in the experiment was trained in an environment without any buildings and the RPL-SAC and model-based RPL-SAC tried to learn a residual policy in an environment with buildings. As shown in FIGS. 5A-5D, the method of the example embodiment converged to a better performance than the initial policy and without a drop. In some embodiments, the initial policy can be trained in simulation while the method is executed in the real world, or initial policy can be a hand-engineered policy e.g., rule-based.

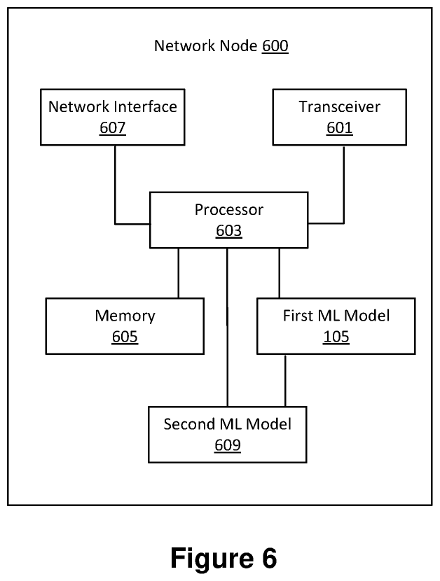

The method of the present disclosure may be performed by a network node (e.g., network node 600 of FIG. 6 or network node 1200 of FIG. 12). For example, modules may be stored in memory 603 of FIG. 6 or 1204 of FIG. 12, and/or in first ML model 105/second ML model 609, and these modules may provide instructions so that when the instructions of a module are executed by processing circuitry 603 of FIG. 6 and or 1202 of FIG. 12, the network node 600, 1200 performs respective operations of the method in accordance with various embodiments of the present disclosure.

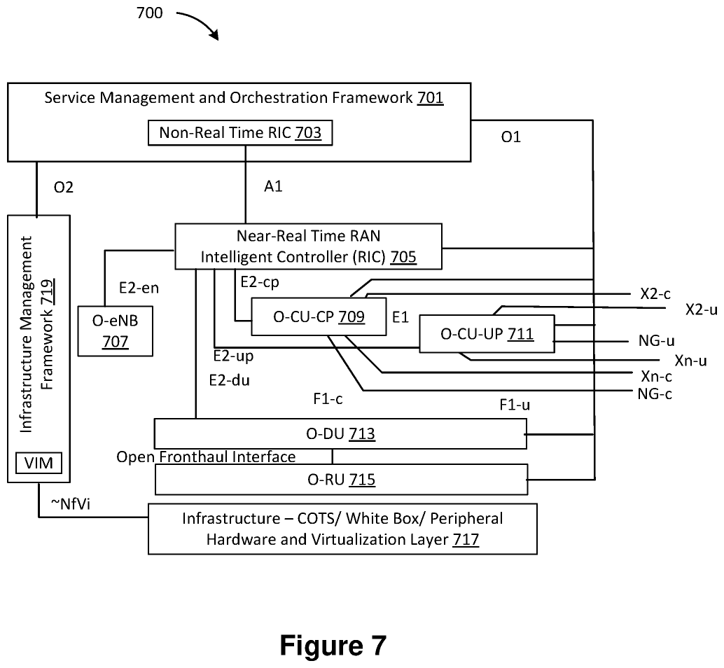

In some embodiments, the method can be performed in an O-RAN environment as illustrated, e.g., in FIG. 7. In an O-RAN 700 environment, the network node may include an r-App in a non-real time RAN intelligent controller (RIC) 703, which may be part of a service management and orchestration functionality 701. The state and action information may be transmitted over the A1, O1, and O2 interfaces, e.g., when an antenna tilt functionality runs as an x-App in the near-real time RAN RIC, etc. When the action is transmitted, a function in the near-real time RAN intelligent controller (RIC) 705 may send antenna configuration change to be implemented through the E2 interfaces to the distributed unit O-DU 713 and the radio unit O-RU 715 or to the O-eNB 707 for LTE networks. If the parameter changes involve modification to the control plane or user plane, the near-real time RIC 705 may send information to the central unit control plane O-CU-CP 709 or to the central unit user plane O-CU-UP 711 respectively. The functions in the near-real time RIC 705, O-DU 713, O-RU 715, O-CU-CP 709, O-CU-UP 711 may be virtualized to a virtualization layer 717. Information about the infrastructure may be sent to the non-real time RIC 703 through the infrastructure management framework 719 and the O2 interface. This information can be used as the state. Network information can be communicated to the r-App through the O1 interface by the near real time RIC 705, O-DU 713, O-RU 715, O-eNB 707, O-CU-CP 709, or O-CU-UP 711.

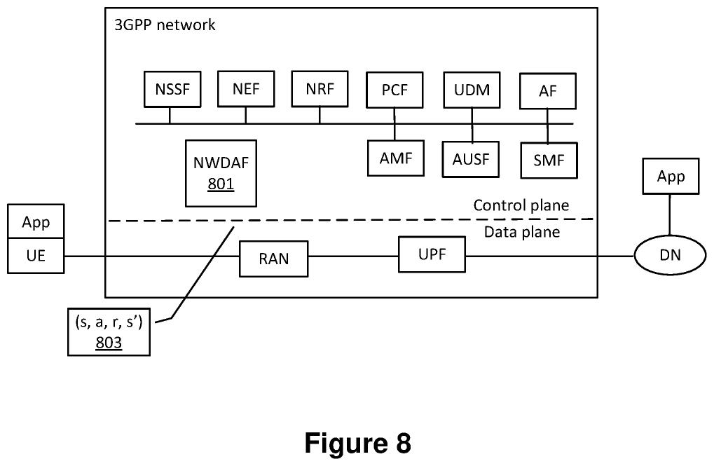

In some embodiments, the policy and environment models are shared across base stations. Data from all the base stations in the environment may be collected to train the model and residual policy. In some embodiments, the method of the signaling diagram of FIG. 3 may be deployed in a third generation partnership project (3GPP) RAN environment as illustrated in the example architecture of FIG. 8.

For example, as illustrated in FIG. 8, the network node may be deployed within a Network Data Analytics Function (NWDAF) 801 part of a 3GPP network. The network node e.g., NWDAF 801 may interact with multiple gNBs or other type of base stations e.g., eNBs, etc. through standardized protocols, either directly or indirectly via other network functions in the RAN. Communication between the NWDAF 801 and RAN may include a measured state in a set of base stations in the RAN, actions taken by the performance of the method in the NWDAF, rewards as calculated either in NWDAF or in a base station in the RAN, and state s′ after an action triggered by the NWDAF 801 for e.g., (s, a, r, s′) 803.

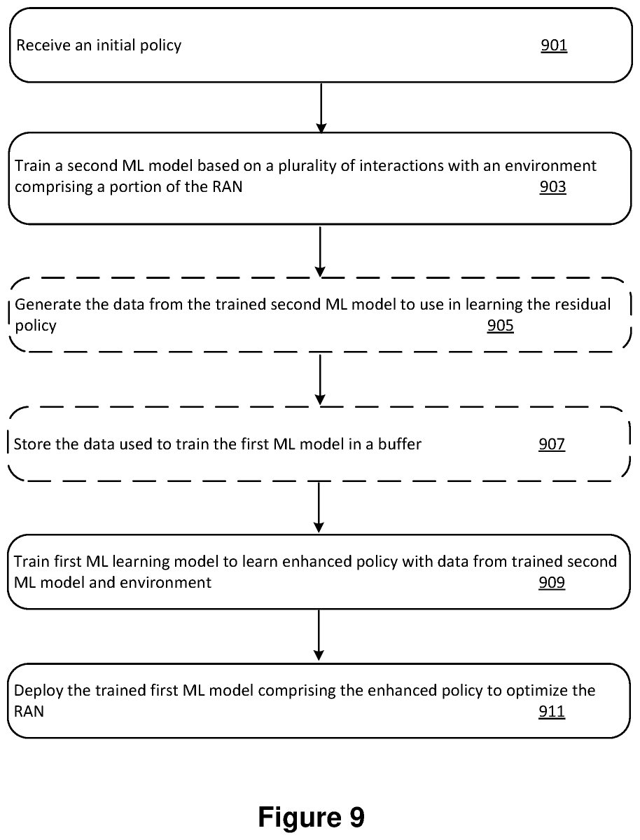

FIG. 9 is a flowchart illustrating operations of a computer-implemented method performed by a network node (e.g., network node 600, 1200 discussed herein) comprising a first machine learning, ML, model (e.g., first ML model 105) representing an enhanced policy to optimize a RAN. The method includes receiving (901) an initial policy. The method further includes training (903) a second machine learning, ML, model based on a plurality of interactions with an environment comprising a portion of the RAN. The method further includes training (909) the first ML learning model to learn the enhanced policy with data from the trained second ML model and the environment; and deploying (911) the trained first ML model comprising the enhanced policy to optimize the RAN.

The initial policy may control the RAN parameter and the initial policy includes a mapping from an observation to an action and can be obtained from one or more rule-based model, traditional control algorithm, or a ML model trained in a different environment or in a simulation of a different environment.

The second ML model may include a transition model. The transition model may include a neural network.

The environment may include a simulated RAN environment and/or a real RAN environment.

The training (903) of the second ML model based on a plurality of interactions with the environment may include receiving an input at the second ML model including (i) a current state in the environment and (ii) a proposed action and outputting a probability distribution over a plurality of next possible states in the environment.

The training (903) of the second ML model may include maximizing a maximum likelihood of data sampled from the plurality of interactions with the environment (e.g., by minimizing a mean squared error loss function between the generated data and the data sampled from the environment).

The data sampled may be collected from at least one of the plurality of interactions with the environment. A set of data used to train the second ML model may be collected by a learning policy that includes exploration.

The training (903) the second ML model may include learning a learned residual policy.

In some embodiments, the method further includes generating (905) the data from the trained second ML model to use in learning the learned residual policy. The learning may be based on a multiple update learning operation using the generated data.

The multiple update learning operation may include, for a series of time steps in a defined time interval, (i) determining a first action based on the initial policy for a first state for a first time step in the time interval, a policy correction term for the first state, and an exploration noise value (ii) determining a next state for a next time step in the time interval from the trained second ML model based on the first state and the first action, and (iii) determining a first reward for the first state, the first action, and the next state.

The data sampled from the plurality of interactions with the environment may include: a state in the environment, an action associated with the state, a new state in the environment observed after an execution of the action, and a reward based on a parameter in the environment.

In some embodiments, the method further includes storing (907) the data used to train the first ML model in a buffer.

The trained first ML model may include the initial ML model combined with a learned residual policy for example the approximate model 401 discussed above.

The initial policy combined with the learned residual policy may include one or more of a sum of the initial policy and the learned residual policy, a multiplication of the initial policy and the learned residual policy, and a weighted sum of the initial policy and with learned weights of the learned residual policy.

The learned residual policy term may be learned using reinforcement learning. The reinforcement learning may include using data sampled from the data from the trained second ML model.

The network node may be deployed in a NWDAF.

The network node may be deployed as an r-app in non-real time RAN RIC.

The network node may include at least one of a base station, an edge node, and a cloud node.

A parameter of the RAN may include at least one of tuning an antenna tilt, setting an azimuth angle of an antenna, setting a downlink transmission power of an antenna, setting an individual offset of a cell, setting an uplink power, setting a downlink power, and setting a quality of service, QoS, class in a cell.

Various operations from the flow chart of FIG. 9 may be optional with respect to some embodiments of network nodes and related methods. For example, the operations of blocks 905 and 907 of FIG. 9 may be optional.

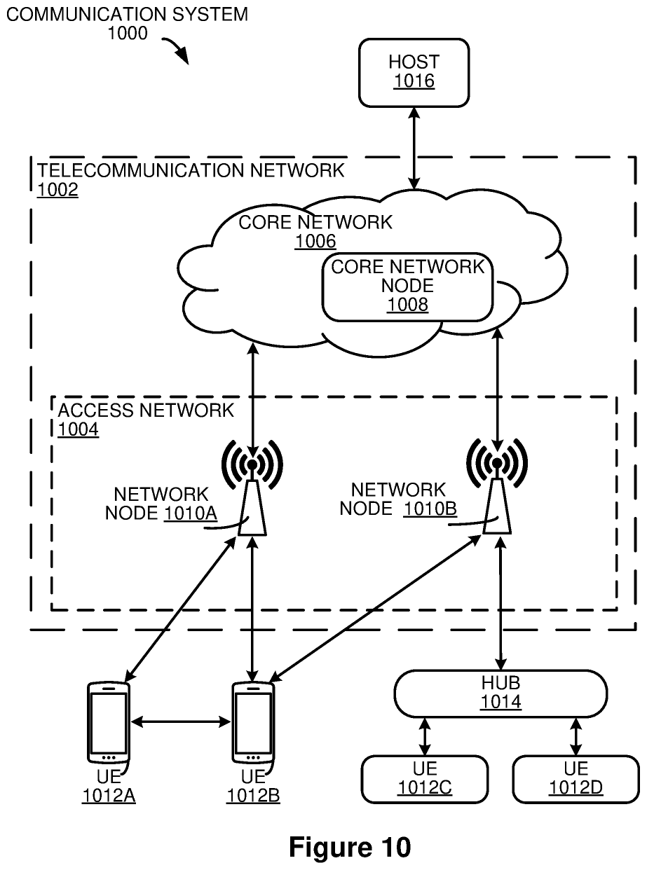

FIG. 10 shows an example of a communication system 1000 in accordance with some embodiments.

In the example, the communication system 1000 includes a telecommunication network 1002 that includes an access network 1004, such as a RAN, and a core network 1006, which includes one or more core network nodes 1008. The access network 1004 includes one or more access nodes, such as network nodes 1010a and 1010b (one or more of which may be generally referred to as network nodes 1010), or any other similar 3GPP access node or non-3GPP access point. The network nodes 1010 facilitate direct or indirect connection of UE, such as by connecting UEs 1012a, 1012b, 1012c, and 1012d (one or more of which may be generally referred to as UEs 1012) to the core network 1006 over one or more wireless connections. Communication system 1000 may include a NTN network (not illustrated) communicatively connected to the telecommunication network 1002.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes (including satellite/NTN network nodes), UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the nodes 1010 are arranged, capable, configured, and/or operable to communicate directly or indirectly with the UEs 1012 and/or with other nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, nodes may be directly coupled to hosts. The core network 1006 includes one more core network nodes (e.g., core network node 1008) that are structured with hardware and software components. Features of these components may be substantially similar to those described with respect to the UEs, nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1014 communicates with the access network 1004 to facilitate indirect communication between one or more UEs (e.g., UE 1012c and/or 1012d) and nodes (e.g., node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the node 1010b. In other embodiments, the hub 1014 may be a non-dedicated hub—that is, a device which is capable of operating to route communications between the UEs and node 1010b, but which is additionally capable of operating as a communication start and/or end point for certain data channels.

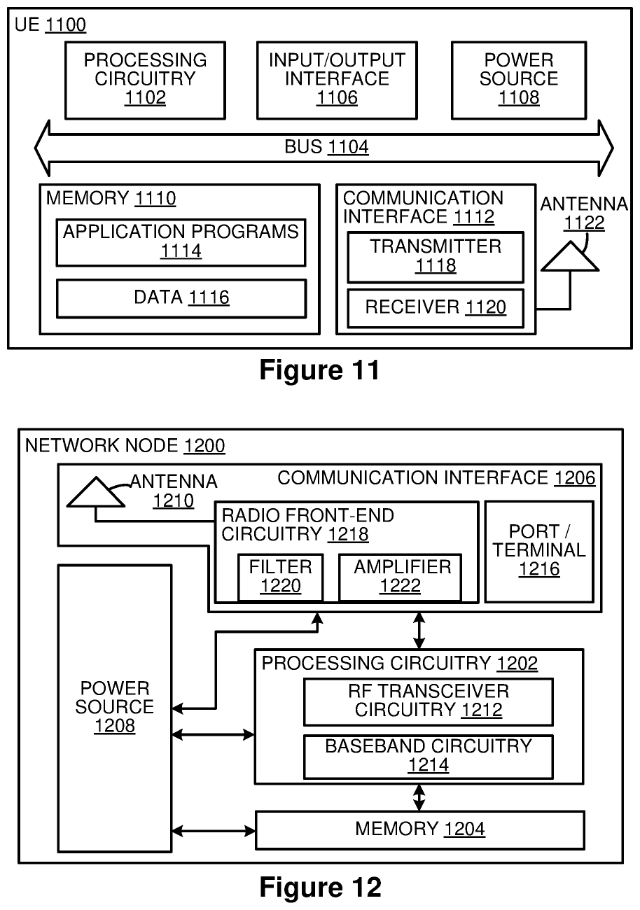

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 10. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 10.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As previously discussed herein, a network node refers to equipment capable, configured, arranged, and/or operable to communicate directly or indirectly with a UE and/or with other network nodes or equipment, in a communication system (including a TN-NTN network). Examples of network nodes include, but are not limited to, base stations (BSs) in a TN and/or a NTN (e.g., Node Bs, eNBs, and NR NodeBs (gNBs)), central network nodes, and access points (APs) (e.g., radio access points).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A node may also include one or more (or all) parts of a distributed base station such as centralized digital units and/or remote radio units (RRUs), sometimes referred to as Remote Radio Heads (RRHs). Such remote radio units may or may not be integrated with an antenna as an antenna integrated radio. Parts of a distributed base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several nodes. For example, a single RNC may control multiple NodeBs. In such a scenario, each unique NodeB and RNC pair, may in some instances be considered a single separate node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the node network 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the node. Any information, data and/or signals may be received from a UE, another node and/or any other network equipment. Similarly, the antenna 1210, the communication interface 1206, and/or the processing circuitry 1202 may be configured to perform any transmitting operations described herein as being performed by the node. Any information, data and/or signals may be transmitted to a UE, another node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

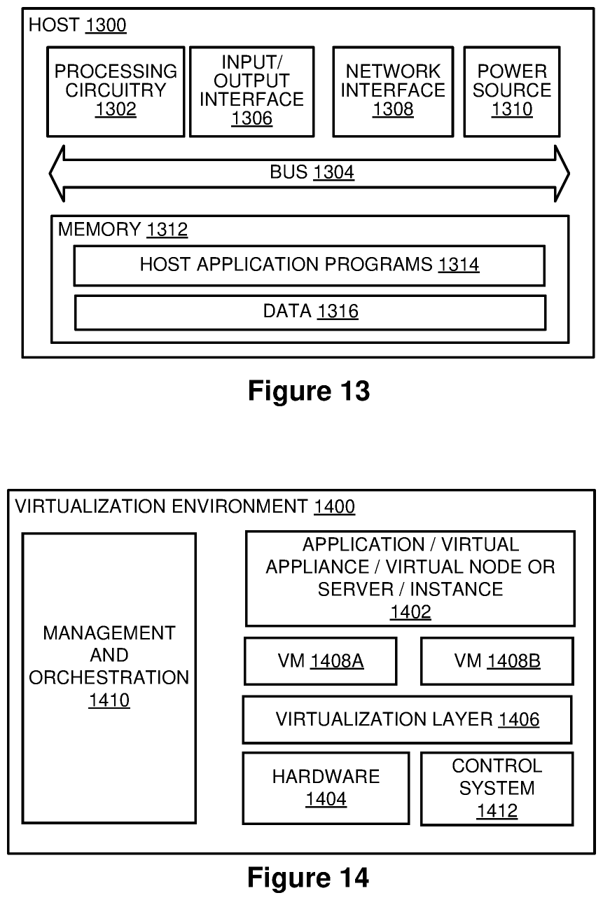

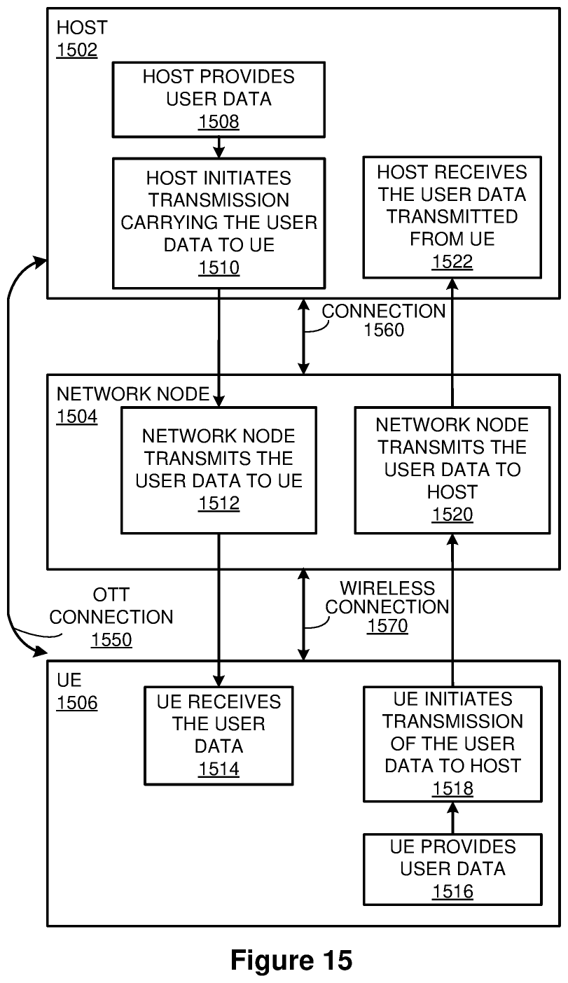

FIG. 13 is a block diagram of a host 1300, which may be an embodiment of the host 1016 of FIG. 10, in accordance with various aspects described herein. As used herein, the host 1300 may be or comprise various combinations hardware and/or software, including a standalone server, a blade server, a cloud-implemented server, a distributed server, a virtual machine, container, or processing resources in a server farm. The host 1300 may provide one or more services to one or more UEs.

The host 1300 includes processing circuitry 1302 that is operatively coupled via a bus 1304 to an input/output interface 1306, a network interface 1308, a power source 1310, and a memory 1312. Other components may be included in other embodiments. Features of these components may be substantially similar to those described with respect to the devices of previous figures, such as FIGS. 11 and 12, such that the descriptions thereof are generally applicable to the corresponding components of host 1300.

The memory 1312 may include one or more computer programs including one or more host application programs 1314 and data 1316, which may include user data, e.g., data generated by a UE for the host 1300 or data generated by the host 1300 for a UE. Embodiments of the host 1300 may utilize only a subset or all of the components shown. The host application programs 1314 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1314 may also provide for user authentication and licensing checks and may periodically report health, routes, and content availability to a central node, such as a device in or on the edge of a core network. Accordingly, the host 1300 may select and/or indicate a different host for over-the-top services for a UE. The host application programs 1314 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 14 is a block diagram illustrating a virtualization environment 1400 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1400 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1402 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1404 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1406 (also referred to as hypervisors or virtual machine monitors (VMMs)), provide VMs 1408a and 1408b (one or more of which may be generally referred to as VMs 1408), and/or perform any of the functions, features and/or benefits described in relation with some embodiments described herein. The virtualization layer 1406 may present a virtual operating platform that appears like networking hardware to the VMs 1408.

The VMs 1408 comprise virtual processing, virtual memory, virtual networking or interface and virtual storage, and may be run by a corresponding virtualization layer 1406. Different embodiments of the instance of a virtual appliance 1402 may be implemented on one or more of VMs 1408, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1408 may be a software implementation of a physical machine that runs programs as if they were executing on a physical, non-virtualized machine. Each of the VMs 1408, and that part of hardware 1404 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1408 on top of the hardware 1404 and corresponds to the application 1402.

Hardware 1404 may be implemented in a standalone network node with generic or specific components. Hardware 1404 may implement some functions via virtualization. Alternatively, hardware 1404 may be part of a larger cluster of hardware (e.g. such as in a data center or CPE) where many hardware nodes work together and are managed via management and orchestration 1410, which, among others, oversees lifecycle management of applications 1402. In some embodiments, hardware 1404 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1412 which may alternatively be used for communication between hardware nodes and radio units.

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1012a of FIG. 10 and/or UE 1100 of FIG. 11), network node (such as network node 1010a of FIG. 10 and/or network node 1200 of FIG. 12), and host (such as host 1016 of FIG. 10 and/or host 1300 of FIG. 13) discussed in the preceding paragraphs will now be described with reference to FIG. 16.

Like host 1300, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1006 of FIG. 10) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, the teachings of these embodiments may improve sampling efficiency and thereby provide benefits such as faster training.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above, or supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency and the like, by the host 1602. The measurements may be implemented in that software causes messages to be transmitted, in particular empty or ‘dummy’ messages, using the OTT connection 1650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

In the above description of various embodiments of the present disclosure, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus, a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the examples of embodiments and their equivalents, and shall not be restricted or limited by the foregoing detailed description.

1.-30. (canceled)

31. A computer-implemented method for optimizing a radio access network (RAN), the method performed by a network node and comprising:
training a second machine learning (ML) model based on a plurality of interactions with an environment comprising a portion of the RAN;
using data from the trained second ML model and the environment, training a first ML learning model to learn an enhanced policy to optimize the RAN; and
deploying the trained first ML model representing the enhanced policy to optimize the RAN.

32. The method of claim 31, wherein the second ML model comprises a transition model that includes a neural network.

33. The method of claim 31, wherein the environment comprises one or more of the following: a simulated RAN environment, and a real RAN environment.

34. The method of claim 31, wherein training the second ML model based on a plurality of interactions with the environment comprises:
receiving an input at the second ML model comprising a current state in the environment and a proposed action; and
outputting a probability distribution over a plurality of next possible states in the environment.

35. The method of claim 34, wherein training the second ML model based on a plurality of interactions with the environment further comprises maximizing a maximum likelihood of data sampled from the plurality of interactions with the environment.

36. The method of claim 35, wherein the data sampled from the plurality of interactions with the environment comprises the following: a state in the environment, an action associated with the state, a new state in the environment observed after an execution of the action, and a reward based on a parameter in the environment.

37. The method of claim 31, wherein the second ML model is trained using data collected by a learning policy that includes exploration.

38. The method of claim 31, wherein:
the method further comprises generating the data from the trained second ML model; and
training the second ML model comprises learning a residual policy based on a multiple update learning operation using the generated data.

39. The method of claim 38, wherein the multiple update learning operation comprises, for a series of time steps in a defined time interval:
determining a first action based on an initial policy for a first state for a first time step in the time interval, a policy correction term for the first state, and an exploration noise value;
determining a next state for a next time step in the time interval from the trained second ML model based on the first state and the first action; and
determining a first reward for the first state, the first action, and the next state.

40. The method of claim 31, wherein the trained first ML model comprises a combination of an initial policy and a learned residual policy.

41. The method of claim 40, wherein the combination of the initial policy and the learned residual policy comprises one or more of the following: a sum of the initial policy and the learned residual policy, a multiplication of the initial policy and the learned residual policy, and a weighted sum of the initial policy and with learned weights of the learned residual policy.

42. The method of claim 40, wherein one or more of the following applies:
the initial policy controls setting and/or tunning at least one RAN parameter;
the initial policy comprises a mapping from an observation to an action; and
the initial policy is obtained from one or more of the following: a rule-based model, a control algorithm, and an ML model trained in a different environment or in a simulation of a different environment.

43. The method of claim 42, wherein the initial policy controls setting and/or tuning at least one of the following RAN parameters: an antenna tilt, an antenna azimuth angle, downlink transmission power of an antenna, individual offset of a cell, uplink power, downlink power, and quality of service (QoS) class in a cell.

44. The method of claim 40, wherein the learned residual policy term is learned using reinforcement learning and data sampled from the data from the trained second ML model.

45. The method of claim 31, wherein the network node is deployed as one of the following: a network data analytics function (NWDAF), or an r-app in non-real time RAN intelligent controller, RIC.

46. The method of claim 31, wherein the network node comprises at least one of the following: a base station, an edge node, and a cloud node.

47. A network node configured to optimize a radio access network (RAN), the network node comprising:
processing circuitry; and
memory coupled with the processing circuitry, wherein the memory includes instructions that when executed by the processing circuitry causes the network node to:
train a second machine learning (ML) model based on a plurality of interactions with an environment comprising a portion of the RAN;
using data from the trained second ML model and the environment, train a first ML learning model to learn an enhanced policy to optimize the RAN; and
deploy the trained first ML model representing the enhanced policy to optimize the RAN.

48. The network node of claim 47, wherein execution of the instructions causes the network node to train the second ML model based on a plurality of interactions with the environment by:
receiving an input at the second ML model comprising a current state in the environment and a proposed action;
outputting a probability distribution over a plurality of next possible states in the environment; and
maximizing a maximum likelihood of data sampled from the plurality of interactions with the environment.

49. The network node of claim 47, wherein:
execution of the instructions further causes the network node to generate the data from the trained second ML model; and
execution of the instructions causes the network node to train the second ML model based on learning a residual policy based on a multiple update learning operation using the generated data.

50. The network node of claim 49, wherein execution of the instructions causes the network node to perform the multiple update learning operation based on, for a series of time steps in a defined time interval:
determining a first action based on an initial policy for a first state for a first time step in the time interval, a policy correction term for the first state, and an exploration noise value;
determining a next state for a next time step in the time interval from the trained second
ML model based on the first state and the first action; and
determining a first reward for the first state, the first action, and the next state.
